(19) United States
(12) Patent Application Publication
(10) Pub. No.: US 2014/0311191 A1
(43) Pub. Date: Oct. 23, 2014

(54) DELIVERY VALVE STEM PROVIDED WITH A RADIAL SEALING SYSTEM, AND BULK MATERIAL RESERVOIR PROVIDED WITH A DELIVERY STEM VALVE PROVIDED WITH A RADIAL SEALING SYSTEM

(71) Applicants: Adelcio Braz, Sao Paulo (BR); Luizq Henrique Baptista, Rio Claro (BR); Ricardo Cangiano, Iteuna (BR); Lucas de Almeida Magalhaes, Ribeirao Preto (BR)

(72) Inventors: Adelcio Braz, Sao Paulo (BR); Luizq Henrique Baptista, Rio Claro (BR); Ricardo Cangiano, Iteuna (BR); Lucas de Almeida Magalhaes, Ribeirao Preto (BR)

(73) Assignee: Whirlpool S.A., São Paulo -SP (BR)

(21) Appl. No.: 14/342,216

(22) PCT Filed: Sep. 3, 2012
(86) PCT No.: PCT/BR2012/000334

§ 371 Date: Jul. 15, 2014

(30) Foreign Application Priority Data
Sep. 2, 2011 (BR) PI1104481-10

(51) Int. Cl. D06F 39/02; F16K 31/58

(52) U.S. Cl. CPC D06F 39/02; F16K 31/58
USPC 68/17 A; 251/353; 222/537

(57) ABSTRACT

The present invention pertains to the field of home appliances and refers to a delivery valve stem (1) more specifically intended to be used in laundry machines provided with a reservoir (5) for bulk material storage and delivery, wherein said valve flow delivery is not aligned with its displacement axis, since it comprises a predominantly radial sealing system that contributes to clean surfaces in contact with fluid, thereby promoting reduction in the production of residues from washing products, which may be detached and reach the fabrics stored inside the equipment, damaging them and/or causing several inconveniences.

### FIELD OF THE INVENTION

The present invention pertains to the field of home appliances and refers to a drainage valve stem, more specifically for use in laundry machines provided with a reservoir for bulk material storage and delivery, wherein said valve flow delivery is not aligned with its displacement axis, since it comprises a predominantly radial sealing system that contributes to clean those surfaces in contact with fluid, thereby promoting reduction in the generation of residues from washing products, which may be detached and reach fabrics stored inside the equipment, damaging them and/or causing several inconveniences.

### BACKGROUND OF THE INVENTION

As generally known, nowadays several home appliance models for laundry—more specifically laundry machines—are being produced with bulk material delivery system which are intended to store and dose washing products (mainly detergent and softener) in a more practical and precise ways than the former methods of manually dosing products. Such devices are provided with material drainage valves, which, however, generally present the problem of leaking products, which, when they reach fabrics or clothes stored inside a laundry machine, stain them and cause irreversible damages thereto.

In order to mitigate this problem, drainage of stored products is usually made by ball-type valves with rotational movement. Such valves have good efficiency in reducing residues originated from fluid delivery; nevertheless, they require a rotational movement for its actuation, or mechanical means converting translational into rotational movement, which makes their installation difficulty, mainly in reservoir with size restrictions, as it is the case of those used in laundry machines.

There are also valves with translational movement such as, for example, the one disclosed in BR Utility Model Application No. MU8501002-2, which refers to an assembly consisting of a valve body and a needle-type shutter cooperating with a helical spring. However, it happens that said valves typically present the delivery flow of fluid along the displacement axis thereof, which causes residues to accumulate in the outer regions of elements used to carry out the sealing movement, which may detach and fall over the clothes, thus causing the same reported inconveniences.

Therefore, it can be noted that that there is a need in the art for a drainage valve capable of avoiding as much as possible the production of residues which due to accumulation generated by repeated operations of use end up creating fluid drops or deposits which are likely to be detached and fall on the clothes, leading to inconveniences. Furthermore, valves with translational movement in which flow is not aligned with its displacement axis are not known in the prior art.

### OBJECTS OF THE INVENTION

In view of the foregoing, one object of the present invention is to provide a drainage valve stem for a bulk material reservoir, which mitigates as much as possible the production of residues.

Another object of the present invention is to provide a drainage valve stem with translational movement which, however, has a delivery flow not aligned with the valve displacement axis.

Still another object of the present invention is to provide an easily manufactured and assembled drainage valve stem, which, therefore, does not significantly increase costs of the final equipment in which same will be used.

It should be further mentioned that the present invention aims at allowing for reduction in the frequency of user's cleaning and maintenance procedures.

Further, an object of the present invention is to provide a bulk material reservoir comprising a delivery valve stem having high sealing efficiency and capable of minimizing as much as possible the occurrence of residues.

### SUMMARY OF THE INVENTION

The objects of the present invention are achieved by means of a delivery valve stem of the type used in reservoirs for storing bulk product, wherein said valve stem comprises: a substantially cylindrical upper portion cooperating with at least a compression means; a lower portion with an inner region communicating with the outside by means of rear and forward longitudinal openings, wherein said forward opening extends up to the lower inner surface of the valve stem limited by a lower wall portion, wherein said lower inner surface is defined by at least two inclined surfaces, subdivided by means of at least one wall.

In brief, the present invention comprises means to allow for a radial displacement delivery valve stem to carry out a flow delivery in a radial form.

In a preferred embodiment of the present invention, said two inclined surfaces form an open angle of from 45o to 180o therebetween, preferably 123o therebetween.

Furthermore, preferably said at least two surfaces comprise at least two flow direction channels in a position non-coincident with the direction of the valve stem displacement axis.

Additionally, in a preferred embodiment of the present invention, said deliver valve stem comprises a sealing device surrounding the surface near one of its ends.

Said sealing device can be a ring having deformation characteristics for coupling with reservoir walls—e.g. an “O”-type ring.

The present invention may optionally also comprise at least a first device ensuring a radial position for functional coupling between said valve stem and reservoir, or at least a first device ensuring the axial position for functional coupling between said valve stem and reservoir.

The invention further comprises a bulk material reservoir of the type consisting of a body provided with an actuation button cooperating with a delivery valve stem, characterized in that it is coupled with a support structure cooperating with sealing members and having a nozzle for draining products, said valve stem further comprising a perimeter surface at its upper end for coupling upstream the reservoir surface.

According to the preferred embodiment of the invention, the support structure of said reservoir comprises at least an opening on the upper portion of said support structure communicating with the inner region of said reservoir so as to allow that air admitted during actuation of said valve stem is directed to the inside of the reservoir.

Said reservoir may further provide at least an accommodating structure for said valve stem, comprising a lower and upper opening concentric with the shaft of said valve stem.

Preferably, a coupling between the support structure and reservoir can be made by an ultrasonic welding method or mechanic fitting.

Furthermore, said reservoir comprises at least one second device to ensure a radial position for functional coupling between support structure, valve and reservoir.

Further, in accordance with a preferred embodiment of the invention, said support structure is integrally or removably adapted to said reservoir.

### BRIEF DESCRIPTION OF DRAWINGS

FIG. 1—illustrates a front elevation view of a valve stem built in accordance with the preferred embodiment of the present invention;

FIG. 2—illustrates a side elevation view of said valve stem shown in FIG. 1; FIG. 3—illustrates a lower view of said valve stem of FIG. 1;

FIG. 4—illustrates a schematic longitudinal cut of the valve stem assembly depicted in FIG. 1;

FIG. 5—illustrates a perspective view of mounting of the valve stem assembly of FIG. 4, in a resting or non-use position;

FIG. 6—illustrates a perspective view of mounting of the valve stem assembly of FIG. 5, in an actuation position;

FIG. 7—illustrates a rear view of a reservoir provided with the valve stem of the present invention;

FIG. 8—illustrates a sectioned perspective view of a reservoir provided with the valve stem of the present invention;

FIG. 9—illustrates an isolated and enlarged perspective view of the steel core fastener that aids to secure the reservoir.

### DETAILED DESCRIPTION OF THE INVENTION

Next, the present invention will be described in detail based on working examples represented by the appended drawings.

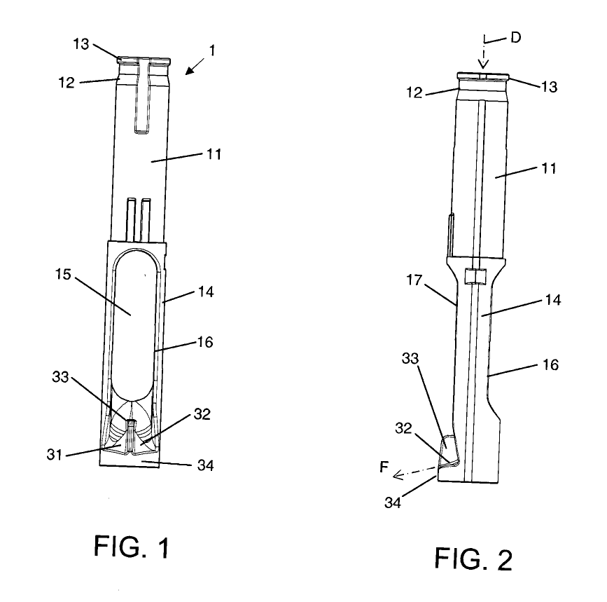

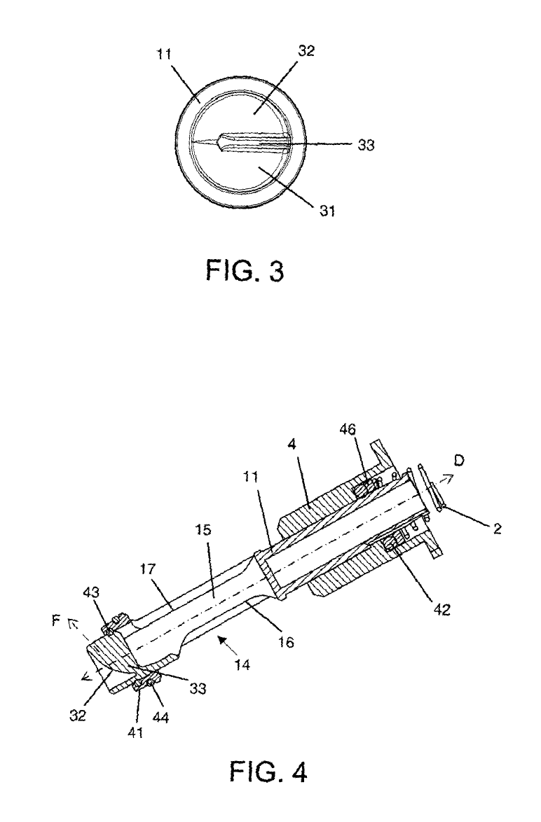

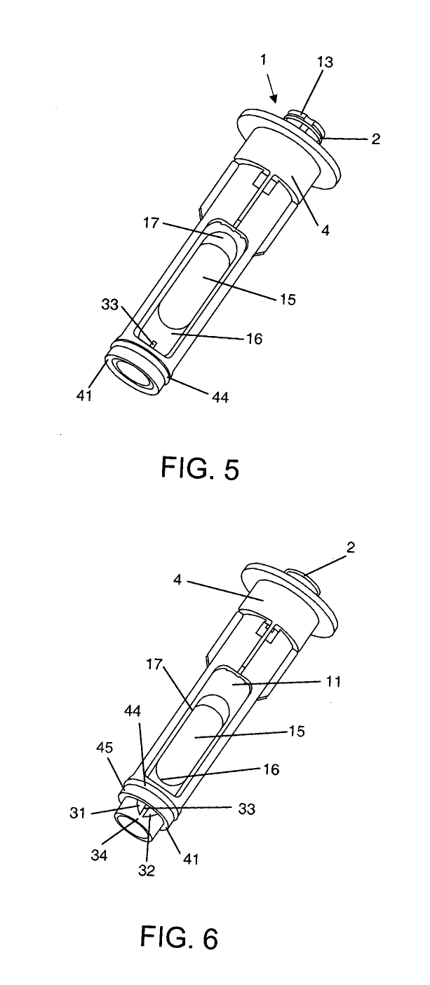

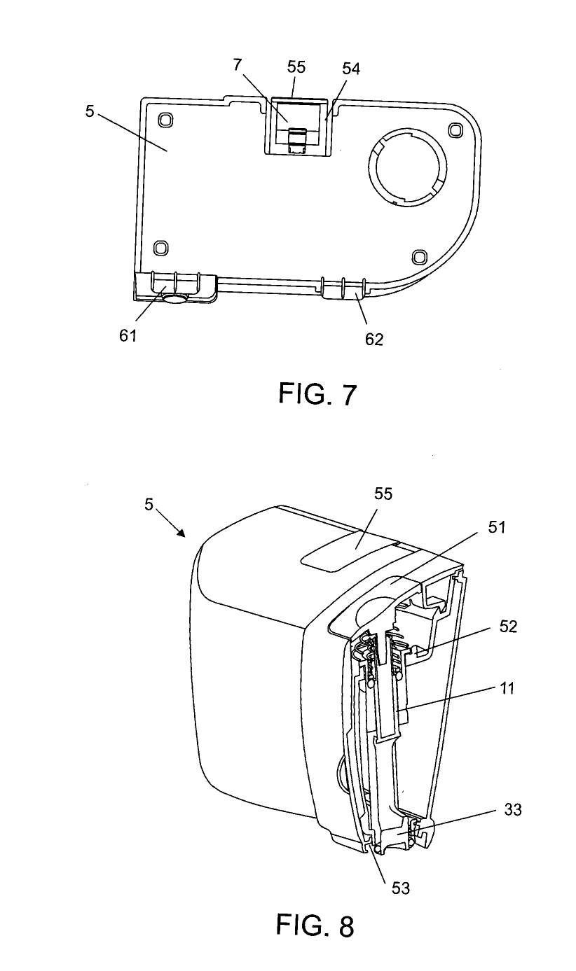

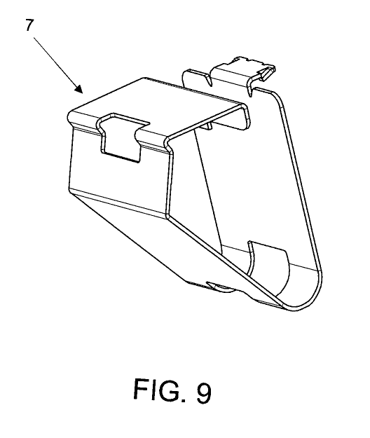

A delivery valve stem 1 made in accordance with the preferred embodiment of the present invention is illustrated in FIGS. 1 and 2, and comprises a substantially cylindrical upper portion 11 with a distal portion 12 preferably having a truncated-conical profile with an end provided with a perimeter rib 13 for coupling a compression means 2, preferably corresponding to a conical spring.

Said lower portion 14 of the valve stem 1 has a cross-section slightly larger than the upper portion 11, wherein its inner region 15 communicating with the outside by means of rear and forward longitudinal openings 16 and 17, wherein said forward opening extends up to the inner lower surface of valve 1 limited by a lower wall portion 34.

Said inner lower portion of valve 1 is defined by two slightly concave conical surfaces 31, 32, divided by a wall 33 preferably in a transversal position to said valve stem 1, said surfaces preferably forming an open angle of 123o therebetween, defining two channels for direction of flow F in a non-coincident position with the displacement axis D of valve 1.

Further, it should be emphasized that said valve 1 may be optionally provided with more than one wall 33, resulting in more than two flow direction channels without departing from the scope of the intended invention.

Mounting of said valve stem 1 is carried out by coupling it within a support structure 4 provided with a nozzle 41 of product outlet, said support structure 4 cooperating with inner 42, 43 and outer 44 sealing members to avoid product linkage.

On said upper sealing member 42 is disposed a perimeter surface 46, e.g. a support ring, cooperating with a compression means 2, which, when appropriately coupled, is kept in a correct operation position by means of a perimeter rib 13. Hence, when in a resting or non-use position, said delivery valve stem 1 remains with its lower end aligned with nozzle 41 of support structure 4, while its distal portion 12 is outside said support structure 4 by means of the action of the ring ou compression means 2.

Said valve stem 1 and its support structure 4 couple to a bulk material storage reservoir 5 of the type consisting of a body comprising an actuation button 51.

To this effect, said reservoir 5 is coupled to the support structure 4 cooperating with sealing members 42, 43 and 44 and provided with a product drainage nozzle 41, wherein said support structure 4 further comprises a perimeter surface 45 at its upper end for coupling upstream the surface of said reservoir 5.

It is important to mention that said support structure 4 comprises at least an opening 47 on its upper portion, communicating with the inner region of reservoir 5 to allow for the air admitted during actuation of the valve stem 1 to be directed inwards the reservoir 5, thereby preventing vacuum generation, which may jeopardize the appropriate flow of the washing product delivery.

Furthermore, said reservoir 5 includes at least an accommodating structure to receive said support structure 4, said accommodating structure comprising an upper opening 52—preferably capable of holding the lower region of an upper support 48 of said support structure 4—and a lower opening, concentric with the shaft of said valve stem 1.

Additionally, it should be pointed out that said support structure 4 can be applied to said reservoir 5 by ultrasound welding or by a mechanical fitting, which may optionally keep it removably secured to reservoir 5.

Moreover, reservoir 5 can also comprise devices ensuring an axial position—such, for example, cracks, guides or protuberances - for coupling those corresponding members eventually contained in the support structure 4 to allow for the assembly to be appropriately positioned such that during the actuation of the valve stem, a bulk material flow is directed inwards the washing basket, or eventually any member cooperating therewith in order to aid the operational process of the equipment.

Analogously, said reservoir can also be provided with devices ensuring radial positions in order avoid inappropriate coupling between the support structure, valve stem 1 and reservoir 5, which can also be constituted by, for example, cracks, cavities, guides, rails or similar members.

For actuation, a user or operator should press on the edge of perimeter rib 13 of said valve stem 1—or any other means for actuation cooperation therewith—thereby pressing the spring or the compression means 2 and causing vertical displacement of the valve stem 1 such that the inner lower surface thereof is lowered and then releases the passage of fluid formerly retained by sealing 45—which may consist of, for example, a wall—of the support structure 4.

When actuation pressing stops, and, therefore, the valve stem begins to return to its initial non-use position, fluid drainage flow progressively ceases due to the own “funnel” format of surfaces 31, 32, until the lower wall portion 34 of said valve stem reaches the sealing device 45 of support member 4, and the sealing system is completed by an inner sealing member 43.

It should be clarified that said sealing means can be “O”-type rings.

Additionally, it can be noted that said reservoir 5 removably couples to a laundry machine lid with which it cooperates by means of a triple fit system comprising at least two lower guide members 61, 62 and a steel core coupling fastener 7 to be adapted within a cavity 54 of reservoir 5 containing a moving lid. Said guide members and the coupling fastener can be better seen from the appended FIGS. 7 and 9.

It should be pointed out that, although a preferred embodiment of the present invention has been shown, eventual omissions, substitutions, and constructional modifications can be made by a person skilled in the art without departing from the spirit and scope of the claimed protection. It has also been expressly predicted that any combinations of features substantially performing the same function so as to reach the same results are within the scope of the present invention. Substitutions of features in a disclosed embodiment by others are also fully intended and contemplated.

Further, it is to be construed that the description based on figures above is only directed to some possible embodiments of the present invention, since the real scope thereof is defined by the appended claims, given that said figures are merely illustrative in character and should not be taken as limitative.

1. Delivery valve stem of the type used in bulk product storage, characterized in that said valve stem (1) comprises:
a substantially cylindrical upper portion (11) cooperating with at least a compression means (2);
a lower portion (14) with inner region (15) communicating with the outside by means of rear (16) and forward (17) longitudinal openings, said forward opening (17) extending up to the inner lower surface of valve stem (1) delimited by a portion of inner wall (34);
said inner lower surface being defined by at least two inclined surfaces (31, 32), subdivided by means of at least a wall (33);
means to allow for an axial displacement delivery valve stem (1) to conduct a radial flow delivery.

2. Delivery valve stem, in accordance with claim 1, characterized in that said two surfaces (31, 32) form an open angle between 45o e 180o therebetween.

3. Delivery valve stem, in accordance with claim 1 or 2, characterized in that said two surfaces (31, 32) form an open angle of 123o therebetween.

4. Delivery valve stem, in accordance with claims 1 and 2, characterized in that said at least two surfaces (31, 32) form at least two channels for direction of flow (F) in a position non-coincident with the direction of the displacement axis (D) of said valve stem (1).

5. Delivery valve stem, in accordance with any of claims 1 to 4, characterized in that it comprises a sealing device (45) surrounding a surface near one of its ends.

6. Delivery valve stem, in accordance with claim 5, characterized in that said sealing device (45) is a ring having deformation characteristics for coupling with reservoir walls.

7. Delivery valve stem, in accordance with claim 1, characterized in that it comprises at least a first device ensuring radial position for functional coupling between said valve stem (1) and said reservoir (5).

8. Delivery valve stem, in accordance with claim 1, characterized in that it comprises at least one first device ensuring axial position for functional coupling between said valve stem (1) and reservoir (5).

9. Bulk material reservoir of the type comprising a body provided with an actuation button (51) cooperating with a delivery valve stem (1) as defined in any of claims 1 to 3, characterized in that it is coupled to a support structure (4) cooperating with sealing members (42, 43, and 44) and provided with a product drainage nozzle (41), said support structure (44) further comprising a perimeter surface (46) at its upper end for coupling upstream the surface of said reservoir (5).

10. Reservoir, in accordance with claim 9, characterized in that said support structure (4) comprises at least an opening (47) in the upper portion of the support structure (4) communicating with the inner region of said reservoir (5) to allow for air admitted during actuation of said valve stem (1) to be directed inward said reservoir (5).

11. Reservoir, in accordance with claim 7, characterized in that it comprises at least an accommodating structure for said valve stem (1), comprising lower (53) and upper (52) openings concentric with the shaft of said valve stem (1).

12. Reservoir, in accordance with claim 7, characterized in that said coupling between the support structure (4) and reservoir (5) is made by ultrasound welding method.

13. Reservoir, in accordance with claim 4, characterized in that said coupling between the support structure (4) and reservoir (5) is made by mechanical fitting.

14. Reservoir, in accordance with claim 1, characterized in that it comprises at least one second device ensuring the axial position for coupling the support structure (4), valve stem (1) and reservoir (5).

15. Reservoir, in accordance with claim 1, characterized in that it comprises at least a second device ensuring the radial position for coupling the support structure (4), valve stem (1) and reservoir (5).

16. Reservoir, in accordance with claim 11, characterized in that said support structure (4) is integrally adapted to reservoir (5).

17. Reservoir, in accordance with claim 11, characterized in that said support structure (4) is removably adapted to reservoir (5).
